(19) United States
(12) Patent Application Publication
(10) Pub. No.: US 2005/0081638 A1
(43) Pub. Date: Apr. 21, 2005

(54) Sensing diaphragm for a differential pressure sensor with over-pressure protection and methods

(76) Inventors: Philip R. Couch, Honiton (GB); David M. Dixon, Salem, VA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/934,327

(22) Filed: Sep. 3, 2004

Related U.S. Application Data
(60) Provisional application No. 60/500,252, filed on Sep. 5, 2003.

(51) Int. Cl. G01L 13/02

(52) U.S. Cl. 73/716

(57) ABSTRACT

A differential pressure sensor includes a housing having first and second housing members. The first and second housing members define opposing sections of a pressure chamber. The differential pressure sensor also includes a multi-layer laminate forming a pressure sensing diaphragm. The diaphragm is positioned between the first and the second housing members such that it generally bisects the pressure chamber into first and second chamber sections such that a pressure differential between the chamber sections causes the diaphragm to deflect toward the chamber section having the lower pressure. The first and second housing members are positioned to provide an overpressure stop that limits deflection of the diaphragm beyond a predetermined deflection limit.

### CROSS-REFERENCES TO RELATED APPLICATIONS

This application is a non-provisional of, and claims the benefit of, co-pending, U.S. Provisional Application No. 60/500,252, entitled “SENSING DIAPHRAGM FOR A DIFFERENTIAL PRESSURE SENSOR WITH OVER-PRESSURE PROTECTION AND METHOD OF CONSTRUCTING SAME,” filed on Sep. 5, 2003, by Philip R. Couch, et al., the entire disclosure of which is herein incorporated by reference for all purposes.

### BACKGROUND OF THE INVENTION

Embodiments of the present invention relate generally to pressure sensing systems. More specifically, embodiments of the present invention provide differential pressure sensors having overpressure protection.

Differential pressure sensors have many uses. On example is measuring fluid flow in a pipe. A pressure tap may be placed on either side of a flow restriction, and the pressure difference between the taps provides an indication of the rate fluid is flowing through the pipe.

Pressure sensors for some applications (e.g., high pressure applications) often are large and heavy. This may be the case because the diaphragm whose deflection is used to measure pressure differentials must be able to withstand large differences without rupturing. Such devices, however, may not be suitable for certain applications that would benefit from lighter weight, lower cost, portable differential pressure sensors. Thus, improved differential pressure sensors are needed.

### BRIEF SUMMARY OF THE INVENTION

Embodiments of the invention thus provide a differential pressure sensor. The differential pressure sensor includes a housing having first and second housing members. The first and second housing members define opposing sections of a pressure chamber. The differential pressure sensor also includes a multi-layer laminate forming a pressure sensing diaphragm. The diaphragm is positioned between the first and the second housing members such that it generally bisects the pressure chamber into first and second chamber sections such that a pressure differential between the chamber sections causes the diaphragm to deflect toward the chamber section having the lower pressure. The first and second housing members are positioned to provide an overpressure stop that limits deflection of the diaphragm beyond a predetermined deflection limit.

In some embodiments of the differential pressure sensor, the diaphragm includes a deformable disk having first and second sides and a measurement device bonded to the first side of the disk configured to sense shape changes in the disk. The measurement device has a thickness and covers only a portion of the first side of the disk. The diaphragm also includes a first spacer having a thickness generally equal to the thickness of the measurement device and generally covering the portion of the first side of the disk not covered by the measurement device. The diaphragm also includes a second spacer bonded to the second side of the disk. The second spacer has a thickness generally equal to the thickness of the first spacer. The diaphragm also includes first and second cover plates bonded to opposing spacers. The measurement device may be a strain gauge. The strain gauge may include at least two differential resistor pairs, a first differential resistor pair positioned near a middle portion of the disk and a second differential resistor pair positioned near a periphery portion of the disk. The at least two differential resistor pairs may be wired together as a Wheatstone bridge network. The first and second spacers may be polyimide. The deformable disk may be stainless steel. The deformable disk may have a thickness of about 0.25 millimeters. The first and second cover plates may be stainless steel having a thickness of approximately 0.025 millimeters. The differential pressure sensor also may include a temperature sensing device configured to measure the temperature of the diaphragm.

In further embodiments a pressure sensing diaphragm is adapted for insertion between opposing sections of a housing. The opposing sections define first and second pressure chambers and the diaphragm is positioned to deflect in response to pressure differences between the first and second champers. The housing sections further define deflection stops that prevent the diaphragm from deflecting beyond a pre-determined limit. The diaphragm includes a deformable disk having first and second sides and a measurement device bonded to the first side of the disk configured to sense shape changes in the disk. The measurement device has a thickness and covers a first portion of the first side of the disk. The diaphragm includes a first spacer having a thickness generally equal to the thickness of the measurement device and generally covering a second portion of the first side of the disk not covered by the measurement device. The diaphragm further includes a second spacer bonded to the second side of the disk. The second spacer has a thickness generally equal to the thickness of the first spacer. The diaphragm also includes first and second cover plates bonded to opposing spacers.

In some embodiments the pressure sensing diaphragm may include a temperature sensor configured to measure the temperature of the diaphragm. The sensor may be a strain gauge. The strain gauge may include a plurality of sensors wired as a Wheatstone bridge network.

In still other embodiments a method of assembling a differential pressure sensor includes bonding a sensor to a first side of a deformable disk, laminating spacers to a second side of the disk and a portion of the first side of the disk, thereby forming layers having substantially equal thickness on either side of the disk, and bonding first and second cover plates to either side of the disk, thereby forming a pressure sensing diaphragm. The cover plates comprise anti-corrosive material with respect to a fluid medium for which the pressure sensor is used. The method also includes installing the pressure sensing diaphragm between first and second housing members. The housing members, together with the diaphragm, form first and second pressure chambers on opposing sides of the pressure sensing diaphragm. At least one of the first and second housing members may be positioned to provide an overpressure stop that prevents the pressure sensing diaphragm from deflecting beyond a pre-determined distance. Bonding a sensor to a first side of a deformable disk may include bonding a multi-sensor strain gauge to the disk. The sensors may be wired as a Wheatstone bridge network. The method may include bonding a temperature sensor to the first side of the disk. Installing the pressure sensing diaphragm between first and second housing members may include clamping the members together with a force in excess of about 1,000 kg. The method may include cooling the housing members to below a predetermined temperature prior to the installing the diaphragm to thereby introduce a tension force in the diaphragm following the clamping step.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A illustrates an exploded view of a pressure sensing diaphragm according to embodiments of the invention.

FIG. 1B illustrates the assembled pressure sensing diaphragm of FIG. 1A.

FIG. 1C illustrates an embodiment of a strain gauge that may be used with the pressure sensing diaphragm of FIG. 1A.

FIG. 2 illustrates an exploded view of a pressure sensor using the pressure sensing diaphragm of FIG. 1A.

FIG. 3 illustrates an embodiment of a method of assembling a pressure sensor, such as the pressure sensor of FIG. 2.

FIG. 4 illustrates a pressure sensing device using the pressure sensor of FIG. 2.

### DETAILED DESCRIPTION OF THE INVENTION

Embodiments of the invention relate to a pressure sensor having a multi-layer pressure sensing diaphragm. In some embodiments, the pressure sensing diaphragm converts a differential pressure between two chambers to an imbalance of a strain-gauge-based Wheatstone bridge. Some embodiments correct for temperature variations. Some embodiments prevent corrosive material from contacting the sensor elements by laminating the sensor elements between thin stainless steel films.

In some embodiments, temperature effects are compensated using a balanced laminated buildup. Expansion forces that may give rise to distortion of the diaphragm are cancelled on each side of the plate.

Some embodiments employ an unconventional film strain gauge. Conventional strain gauges are too small to be laminated into a pressure-sensing diaphragm with the electrical connections exposed for connection outside the laminations. Connecting to a smaller gauge within the laminations is not practical. The minimum diaphragm size is constrained by the measurement to be made. In one example, a diaphragm less than about 25 mm in diameter deflects too little to accurately and reliably detect the deflection at certain required pressures.

Some embodiments of the invention may be used in many environments and under a variety of conditions including operation at relatively high static pressures, which is often the case when measuring fluid flow. In a high static pressure application, a partial restriction may be inserted into a fluid pipeline, and a pressure tapping made on either side of the tapping. The difference in pressure between the tappings is related to the flow rate of the fluid. The fluid is often at a high pressure in the pipeline. The pressure sensor is required to operate with this high absolute pressure on each inlet port and accurately measure a small differential pressure with minimal error introduced by the high absolute pressure or by other causes. Of course, embodiments of the invention find utility in many other applications with similar or other constraints. Further, embodiments of the invention also may be used in less demanding applications (e.g., low static pressure fluid flow) that do not require the full range of advantages provided by these embodiments. The invention is not limited to the specific details described and illustrated above.

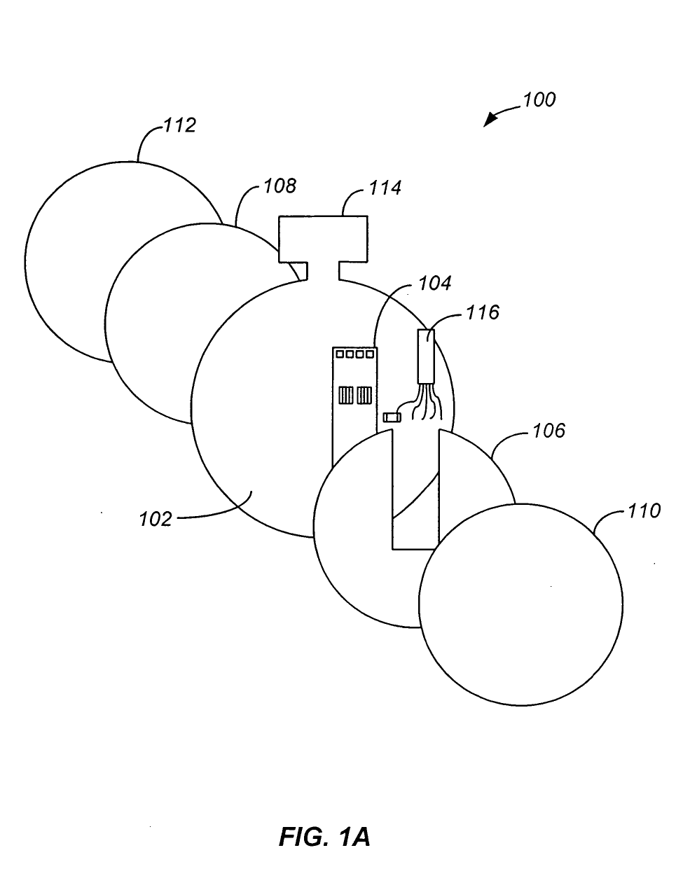

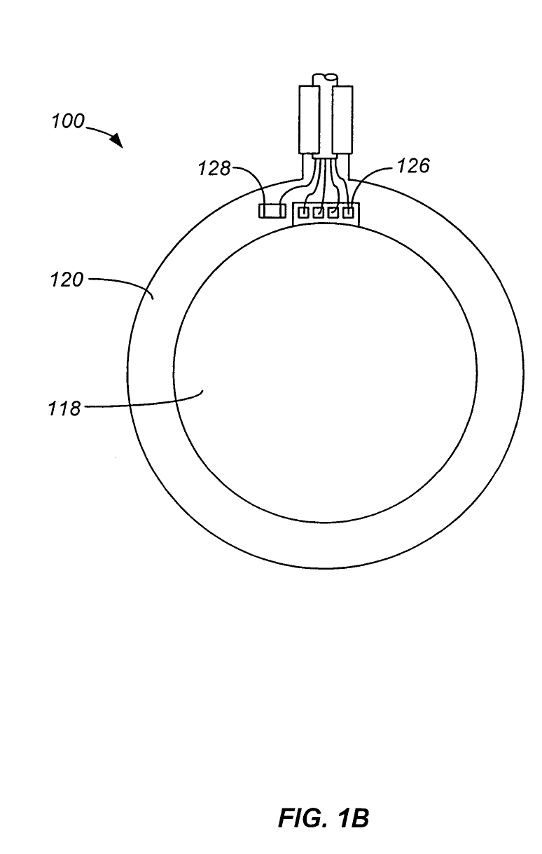

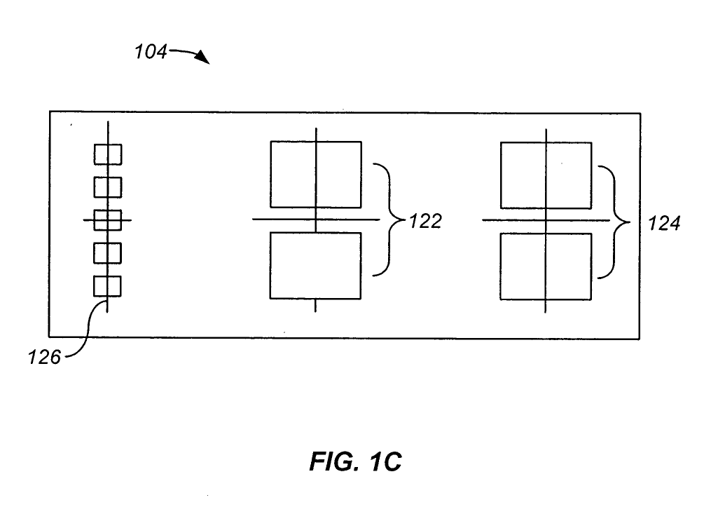

Attention is directed to FIG. 1A, which illustrates an exploded view of an exemplary pressure sensing diaphragm 100 according to embodiments of the invention. The pressure sensing diaphragm 100 consists of a multi-layer laminate having a central disk 102, a strain gauge 104, a first spacer 106, a second spacer 108, a first cover plate 110, and a second cover plate 112. The central disk 102 includes a retention tab 114 configured to engage a cable 116 that caries sensing signals to a processor (not shown). The assembled pressure sensing diaphragm 100 is shown in FIG. 1B.

The central disk 102 may comprise any suitable deformable material, including metal, plastic, and the like. In a specific embodiment, the central disk 102 comprises stainless steel having a thickness of approximately 0.25 millimeters. The central disk 102 defines a generally circular active region 118 and an inactive region 120 generally concentric to the active region.

The strain gauge 104 is also pictured in FIG. 1C. In may be formed on, for example, polyimide or other suitable material. The strain gauge 102 includes two differential resistor pairs 122, 124. The strain gauge 104 is bonded to a first side of the central disk 102 such that a first pair of differential resistors 122 is located near the center of the active region 118 and the other pair of differential resistors 122 is located near an edge of the active region 118. The strain gauge 104 is bonded to the central disk 102 such that electrical contacts 126 are positioned in the inactive region 120. The differential resistor pairs 122, 124 are wired as a Wheatstone bridge network. A temperature sensor 128, configured to measure the temperature of the central disk 102, also is positioned in the inactive region 120.

In some embodiments, the strain gauge 104 covers the entire active region 118 of the central disk 102. In such embodiments, the first spacer 106 may not be necessary. In embodiments in which the strain gauge 104 does not cover the entire active region 118, then the first spacer may be used. The first spacer 106 may be polyimide or other suitable material, and has a thickness substantially equal to the thickness of the strain gauge 102. Thus, the strain gauge 102 and first spacer 106 form a layer of uniform thickness covering the active region 118 of the central disk 102. The second spacer 108 is bonded to the opposite side of the central disk 102. Its size and thickness are substantially similar to the strain gauge/first spacer layer on the opposite side. The second spacer 104 also may comprise polyimide or other suitable material.

The first and second cover plates 110, 112 are bonded to opposing sides of the pressure sensing diaphragm 100, forming the outer layers of the laminate. The cover plates 110, 112 may be stainless steel or other suitable material. The cover plates 110, 112 are sized to cover the active region 118 and, in some embodiments, have a thickness on the order of one-tenth the thickness of the central disk 102.

The cable 116 caries electrical signals from the differential resistor pairs 122, 124 and the temperature sensor 128 to a processor or other signal processor. The signals from the resistor pairs 122, 124 relate to the deflection of the central disk 102. The signals from the temperature sensor 128 may be used in the pressure calculations for greater accuracy.

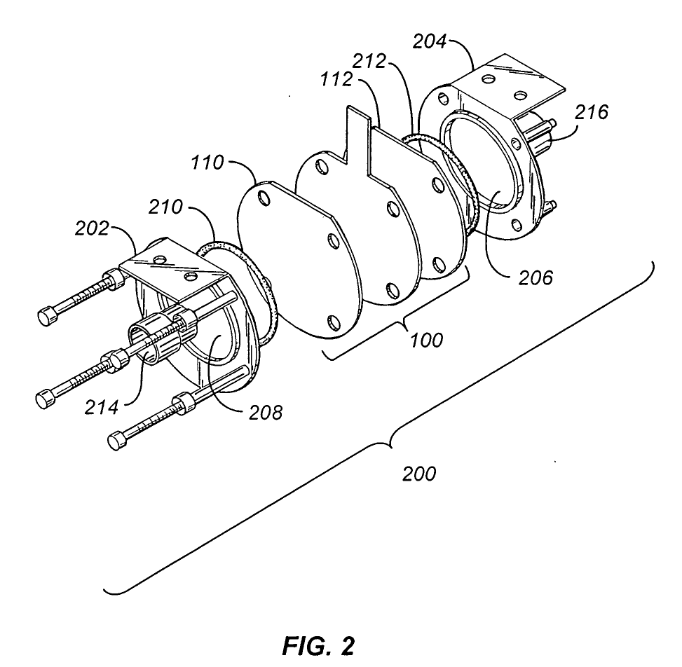

Attention is directed to FIG. 2, which illustrates an exploded view of a pressure sensor 200 using the pressure sensing diaphragm 100 of FIG. 1. The pressure sensing diaphragm 100 is positioned between first and second housing members 202, 204. The housing members 202, 204, together with the cover plates 110, 112, define opposing pressure chambers 206, 208. In addition to providing a pressure chamber, the housing members 202, 204 serve as overpressure stops that prevent the diaphragm 100 from deflecting beyond a predetermined limit. O-rings 210, 212 provide a pressure-tight seal.

The housing members 202, 204, may be stainless steel or other appropriate material. The O-rings 210, 212 may be neoprene or other appropriate material and may be positioned in machined grooves in the housing members 202, 204.

Pressure ports 214, 216 extend into chambers 206, 208 on either side of the diaphragm 100. The ports may be fitted with filters to prevent dirt or debris from entering the chambers 206, 208 and fouling the device. The chambers 206, 208, in this exemplary embodiment, are dome-shaped, generally conforming to the shape of a sphere having a large radius with respect to the size of the device. The housing members 202, 204 prevent the diaphragm 100 from deforming beyond its elastic limit.

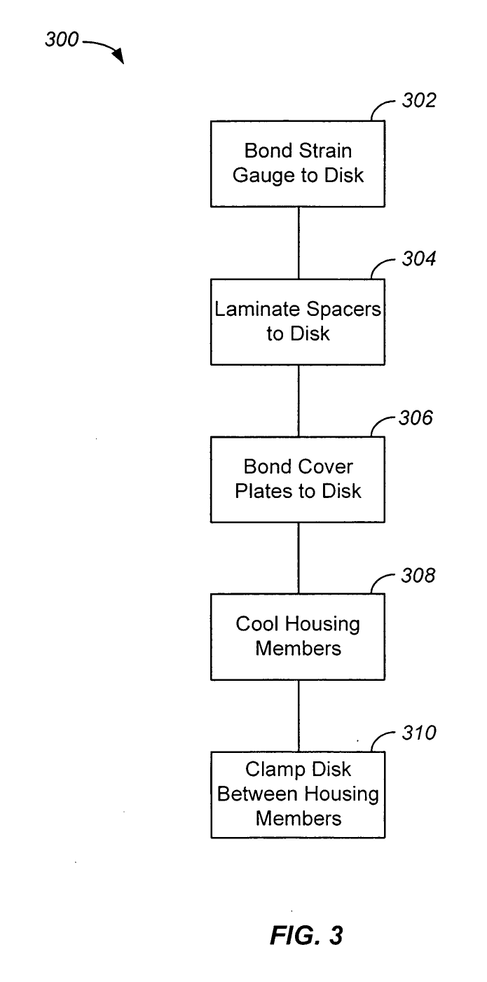

Having described a pressure sensor according to embodiments of the invention, attention is directed to FIG. 3, which illustrates a method 300 of assembling a pressure sensor, such as the pressure sensor 200 of FIG. 2, according to embodiments of the invention. Those skilled in the art will appreciate that the method 300 is merely exemplary of a number of possible methods according to embodiments of the invention. Other methods may include more, fewer, or different steps than those illustrated and described here.

The method 300 begins at block 302 at which point a strain gauge is bonded to a first side of a deformable disk. The sensor may comprise a strain gauge having a plurality of sensors wired as a Wheatstone bridge network as previously described. At block 304, spacers are laminated to both sides of the disk such that the spacer and sensor on one side of the disk have roughly the same thickness as the spacer on the other side of the disk. Cover plates having roughly the same thickness are bonded to either side of the disk at block 306, thereby forming a multi-layer laminate.

At block 308, housing members are cooled to below the temperature of the disk, and the disk is clamped between the housing members at block 310. The clamping force exceeds a predetermined degree of force that, in one embodiment is about 1,000 kg. This prevents the edges of the disk from slipping from between the housing members when the device is exposed to pressure in operation. As a result of cooling the housing members, the disk is exposed to a tension force as the housing members expand upon warming. This may prevent the disk from buckling with temperature gradients. The pressure sensor thus assembled may be employed in a number of useful applications, as is apparent to those skilled in the art, some of which applications are described herein.

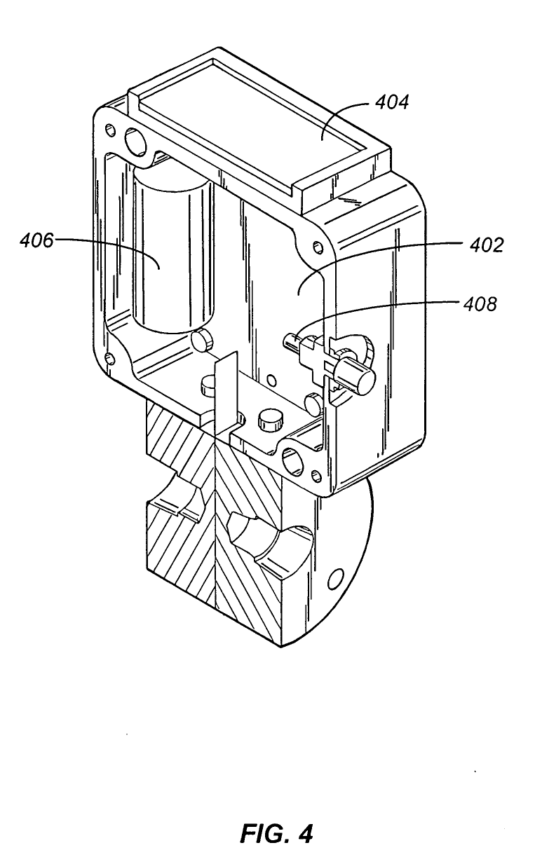

FIG. 4 illustrates a portable pressure monitor 400 that employs the pressure sensor 200 according to embodiments of the invention. The pressure monitor 400 may be positioned such that pressure taps transmit pressure from either side of a restriction in a pipe through which a material is flowing. The differential pressure may be used to determine the flow rate of the material in the pipe. The pressure monitor 400 includes a processor 402, a solar panel 404, a battery 406, and a transmitter 408. The processor 402 receives signals from the strain gauge 104 and temperature sensor 128 and determines the differential pressure between the chambers of the pressure sensor 200. The result may be transmitted to a central monitoring location. The solar power and battery allow the device to be deployed in a number of useful applications.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. For example, those skilled in the art know how to manufacture and assemble electrical devices and components. Additionally, those skilled in the art will realize that the present invention is not limited to measuring fluid flow. Embodiments of the present invention may be configured to measure pressure differentials in a number of applications. Accordingly, the above description should not be taken as limiting the scope of the invention, which is defined in the following claims.

1. A differential pressure sensor, comprising:
a housing having first and second housing members, wherein the first and second housing members define opposing sections of a pressure chamber; and
a multi-layer laminate forming a pressure sensing diaphragm;
wherein the diaphragm is positioned between the first and the second housing members, thereby generally bisecting the pressure chamber into first and second chamber sections such that a pressure differential between the chamber sections causes the diaphragm to deflect toward the chamber section having the lower pressure;
wherein the first and second housing members are positioned to provide an overpressure stop that limits deflection of the diaphragm beyond a predetermined deflection limit.

2. The differential pressure sensor of claim 1, wherein the diaphragm comprises:
a deformable disk having first and second sides;
a measurement device bonded to the first side of the disk configured to sense shape changes in the disk, wherein the measurement device has a thickness and covers only a portion of the first side of the disk;
a first spacer having a thickness generally equal to the thickness of the measurement device and generally covering the portion of the first side of the disk not covered by the measurement device;
a second spacer bonded to the second side of the disk, the second spacer having a thickness generally equal to the thickness of the first spacer; and
first and second cover plates bonded to opposing spacers.

3. The differential pressure sensor of claim 2, wherein the measurement device comprises a strain gauge.

4. The differential pressure sensor of claim 3, wherein the strain gauge comprises at least two differential resistor pairs, a first differential resistor pair positioned near a middle portion of the disk and a second differential resistor pair positioned near a periphery portion of the disk.

5. The differential pressure sensor of claim 4, wherein the at least two differential resistor pairs are wired together as a Wheatstone bridge network.

6. The differential pressure sensor of claim 2, wherein the first and second spacers comprise polyimide.

7. The differential pressure sensor of claim 2, wherein the deformable disk comprises stainless steel.

8. The differential pressure sensor of claim 2, wherein the deformable disk has a thickness of about 0.25 millimeters.

9. The differential pressure sensor of claim 2, wherein the first and second cover plates comprise stainless steel having a thickness of approximately 0.025 millimeters.

10. The differential pressure sensor of claim 1, further comprising a temperature sensing device configured to measure the temperature of the diaphragm.

11. A pressure sensing diaphragm adapted for insertion between opposing sections of a housing, wherein the opposing sections define first and second pressure chambers, the diaphragm being positioned to deflect in response to pressure differences between the first and second champers, wherein the housing sections further define deflection stops that prevent the diaphragm from deflecting beyond a pre-determined limit, the diaphragm, comprising:
a deformable disk having first and second sides;
a measurement device bonded to the first side of the disk configured to sense shape changes in the disk, wherein the measurement device has a thickness and covers a first portion of the first side of the disk;
a first spacer having a thickness generally equal to the thickness of the measurement device and generally covering a second portion of the first side of the disk not covered by the measurement device;
a second spacer bonded to the second side of the disk, the second spacer having a thickness generally equal to the thickness of the first spacer; and
first and second cover plates bonded to opposing spacers.

12. The pressure sensing diaphragm of claim 11, further comprising a temperature sensor configured to measure the temperature of the diaphragm.

13. The pressure sensing diaphragm of claim 11, wherein the sensor is a strain gauge.

14. The pressure sensing diaphragm of claim 13, wherein the strain gauge comprises a plurality of sensors and wherein the sensors are wired as a Wheatstone bridge network.

15. A method of assembling a differential pressure sensor, comprising:
bonding a sensor to a first side of a deformable disk;
laminating spacers to a second side of the disk and a portion of the first side of the disk, thereby forming layers having substantially equal thickness on either side of the disk;
bonding first and second cover plates to either side of the disk, thereby forming a pressure sensing diaphragm, wherein the cover plates comprise anti-corrosive material with respect to a fluid medium for which the pressure sensor is used; and
installing the pressure sensing diaphragm between first and second housing members, wherein the housing members, together with the diaphragm form first and second pressure chambers on opposing sides of the pressure sensing diaphragm, and wherein at least one of the first and second housing members is positioned to provide an overpressure stop that prevents the pressure sensing diaphragm from deflecting beyond a pre-determined distance.

16. The method of claim 15, wherein bonding a sensor to a first side of a deformable disk comprises bonding a multi-sensor strain gauge to the disk, wherein the sensors are wired as a Wheatstone bridge network.

17. The method of claim 15, further comprising bonding a temperature sensor to the first side of the disk.

18. The method of claim 15, wherein installing the pressure sensing diaphragm between first and second housing members comprises clamping the members together with a force in excess of about 1,000 kg.

19. The method of claim 15, further comprising cooling the housing members to below a predetermined temperature prior to the installing the diaphragm to thereby introduce a tension force in the diaphragm following the clamping step.
